(19) United States
(12) Patent Application Publication
(10) Pub. No.: US 2018/0305485 A1
(43) Pub. Date: Oct. 25, 2018

(54) RESIN FOR UNIVERSAL SOLVENTBORNE COLORANTS

(71) Applicant: THE SHERWIN-WILLIAMS COMPANY, CLEVELAND, OH (US)

(72) Inventors: Michael D. Coad, Frankfort, IL (US); Aaron M. Palmer, Saint Anne, IL (US); Catrina A. Shumpert, Country Club Hills, IL (US); Peggy L. Steffy, Hammond, IN (US); Philip J. Ruhoff, Shaker Heights, OH (US); Syed Y. Hasan, Strongsville, OH (US); Timothy B. Kiger, Sagamore Hills, OH (US)

(73) Assignee: THE SHERWIN-WILLIAMS COMPANY, CLEVELAND, OH (US)

(21) Appl. No.: 15/494,609

(22) Filed: Apr. 24, 2017

(51) Int. Cl. C08F 220/18; C09D 133/06; C08K 5/00; C09D 7/12

(52) U.S. Cl. CPC C08F 220/18; C09D 7/1233; C08K 5/0091; C09D 133/062

(57) ABSTRACT

A pigment dispersion resin may include a copolymer including monomer units derived from isobornyl (meth)acrylate and methyl (meth)acrylate. Monomer units derived from isobornyl (meth)acrylate may be present in the copolymer in an amount greater than about 55% by weight, the copolymer may have a number average molecular weight of 3000 or less, and the resin may be substantially completely soluble in mineral spirits. A method of manufacturing a pigment dispersion resin may include providing monomers dissolved in a solvent, adding a chain transfer agent to the solvent, and copolymerizing the monomers. A pigment vehicle may include a plurality of pigment particles and a pigment dispersion resin. A method of manufacturing a coating composition may include combining a carrier liquid and a pigment vehicle. A method of coating a substrate may include applying a coating composition to the substrate.

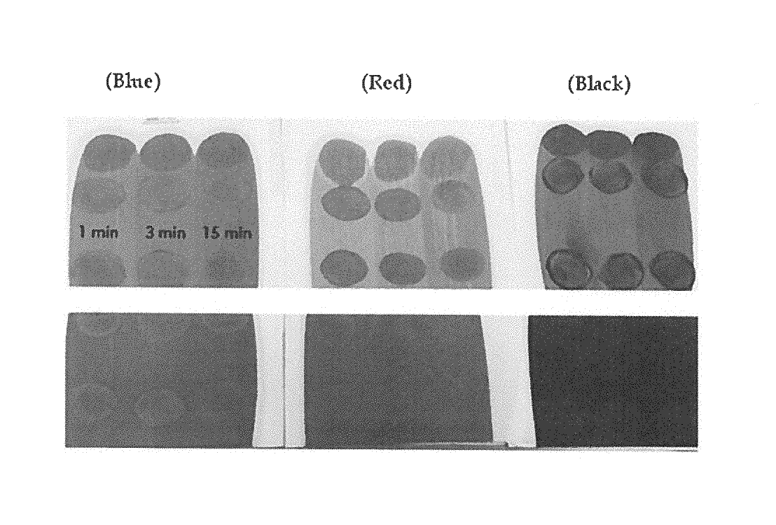

### TECHNICAL FIELD

The present disclosure is generally in the field of resins for paints and other coating compositions. In various non-exclusive embodiments, the disclosure is directed to a pigment dispersion resin, a method of manufacturing a pigment dispersion resin, and a pigment vehicle. In other non-exclusive embodiments, the disclosure is drawn to a method of manufacturing a coating composition, a coating composition, and a method of coating a substrate.

### BACKGROUND

Coating compositions may include color, such as pigment particles. In preparing a coating composition, typically the pigment particles are blended with a dispersion resin that is dissolved in a solvent, and the resulting pigment vehicle is then blended with a binder, a carrier liquid, and other components to form a coating composition. The dispersion resin of the pigment vehicle generally must be compatible with the carrier liquid. Many known acrylic-based dispersion resins are soluble in solvents such as water, ketones, acetates, or aromatics, but such dispersion resins are insoluble or have limited solubility in mineral spirits. For example, commercial resins, such as PARALOID™ DM-55 available from Dow Chemical Company, and LAROPAL® A 81 available from BASF Corporation, each are soluble in certain conventional solvents but in have limited solubility in odorless mineral spirits. Additionally, such solubility in mineral spirits may also serve as an indicator of compatibility with different polymer or resin systems.

Some coating compositions, such as those intended for industrial use in the coating of metal, may include materials such as epoxies, urethanes, and short oil alkyds, and these compositions generally include a carrier liquid having a polar character. Other compositions, such as some compositions intended for industrial coating of wood, may include materials such as medium and long oil alkyds and may include a carrier liquid having a non-polar character, such as odorless mineral spirits. When preparing a coating composition with odorless mineral spirits as the carrier liquid, it is generally necessary to use a pigment vehicle with a dispersion resin that is different from the pigment dispersion resin that would be used for coating compositions with polar carriers.

It would be desirable to provide a pigment dispersion resin that is compatible both with polar carrier liquids and with mineral spirits. Such a pigment dispersion resin would enable a paint manufacturer to use the same pigment dispersion resin in multiple types of coating compositions, including paints having polar carrier liquids and paints having nonpolar carrier liquids. This potentially may achieve simplification of the production processes for a manufacturer that produces various types of paint.

### SUMMARY

Generally, a pigment dispersion resin that comprises a copolymer including monomer units derived from isobornyl (meth)acrylate and one or more other monomers, such as methyl (meth)acrylate, has surprisingly been found to be soluble both in many polar solvents and in mineral spirit solvents. Isobornyl monomers have polar regions, and the solubility of the exemplified resins in mineral spirits was particular surprising. It has been found in particular that when monomer units derived from isobornyl (meth)acrylate are present in the copolymer in an amount greater than about 55% by weight and when the copolymer has number average molecular weight of 3000 or less, the resin may be substantially completely soluble in many conventional polar carrier liquids, such as ketone, acetate, and polar aromatic liquids, but also surprisingly may be substantially completely soluble in mineral spirit carrier liquids. In some embodiments, a portion of the isobornyl (meth)acrylate may be substituted with butyl (meth)acrylate; in such cases, the isobornyl (meth)acrylate and butyl (meth)acrylate together comprise greater than about 55% by weight of the copolymer. While it is not intended to limit the invention to a particular theory of operation, it is believed that different aspects or domains of the copolymer provide the resin with both polar and non-polar characteristics, and that these features of the polymer enable solubility in a wide range of solvents.

The copolymer may be prepared by providing the monomers dissolved in a solvent, preferably in the presence of a chain transfer agent, and copolymerizing the monomers. It has been found in some embodiments that the resin can enable high loading of colorants and that the resulting pigment vehicle will exhibit properties approaching Newtonian behavior, exhibiting good flow properties.

In some aspects, not mutually exclusive with respect to the above, the invention may comprise a pigment vehicle. Generally, the pigment vehicle may comprise a plurality of pigment particles and the pigment dispersion resin described herein. This pigment vehicle may be used in connection with a method of manufacturing a coating composition, which method generally comprises combining a carrier liquid, a binder resin, and the pigment vehicle. An inventive coating composition prepared using the pigment vehicle described herein is encompassed in some inventive aspects. In some embodiments, the invention includes a method for coating a substrate, the method comprising applying the inventive coating composition to the substrate.

### FIGURE

The FIGURE is a series of photographs depicting an evaluation of a pigment vehicle prepared using a prior art resin (top row) and an exemplary resin of the present invention (bottom row). The FIGURE is adapted from a color photograph and the original colors of the compositions shown in photograph are indicated.

### DETAILED DESCRIPTION

The inventive pigment dispersion resin generally comprises a copolymer that comprises monomer units derived from isobornyl (meth)acrylate and monomers other than isobornyl (meth)acrylate, such as methyl (meth)acrylate. Monomer units derived from isobornyl (meth)acrylate generally are present in a majority amount, and may for example be present in an amount of greater than about 55% by weight, greater than about 60% by weight, greater than about 65% by weight, greater than about 70% by weight, greater than about 75% by weight, or greater than about 80% by weight. The copolymer may further include monomer units derived from any one or more suitable other monomers other than isobornyl (meth)acrylate, such as methyl (meth)acrylate, styrene, butyl (meth)acrylate, ethyl (meth)acrylate, 2-ethyl hexyl (meth)acrylate, (meth)acrylic acid, vinyl acetate, 2-hydroxy propyl (meth)acrylate, cyclo hexyl (meth)acrylate, steryl (meth)acrylate, lauryl (meth)acrylate, and alpha-methyl-styrene. The copolymer may include such other monomer units in a collective amount of greater than 1% by weight, greater than 5% by weight, greater than 10% by weight, greater than 15% by weight, greater than 20% by weight, greater than 25% by weight, greater than 30% by weight, or greater than 40% by weight. When more than one other monomer unit is present, such other monomer units may be present in any ratio relative to one another, such as 5:95; 10:90; 15:85; 20:80; 25:75; 30:70; 35:65; 40:60; 45:65; or 50:50 when two monomers other that isobornyl (meth)acrylate are employed, or in any suitable ratio when more than two monomers other than isobornyl (meth)acrylate are employed.

Various blends of the foregoing monomers may be employed, and it is contemplated that many polymeric resins may be prepared consistent with the above recitation. For example, in some exemplary embodiments, monomer units derived from methyl (meth)acrylate may be present in the resin in an amount greater than about 5% by weight, and monomer units derived from styrene may be present in said resin in an amount greater than about 25% by weight. In some exemplary embodiments, monomer units derived from isobornyl (meth)acrylate being present in said resin in an amount greater than about 75% by weight, and monomer units derived from methyl (meth)acrylate being present in said resin in an amount greater than about 20% by weight. In general, it is intended that the monomer units derived from isobornyl (meth)acrylate and other monomers will include a combination of structures having both a polar character, such as hydrophilic groups, and a non-polar character. The copolymer may be essentially free of hydrophilic functional groups derived from monomers other than isobornyl (meth)acrylate and methyl (meth)acrylate. In some embodiments, where the instant invention includes methyl (meth)acrylates, one may substitute (meth)acrylates instead of the methyl (meth)acrylates.

Butyl (meth)acrylate may serve as one of the other monomers in the copolymer, and, in some embodiments, butyl (meth)acrylate also may substitute for a portion of the isobornyl (meth)acrylate in the copolymer. In some embodiments, a monomeric unit which provides a similar level of hydrophobicity as the isobornyl (meth)acrylate may be considered. Monomer units derived from isobornyl (meth)acrylate and monomer units derived from butyl (meth)acrylate may collectively form greater than about 55% by weight, greater than about 60% by weight, greater than about 65% by weight, greater than about 70% by weight, greater than about 75% by weight, or greater than about 80% by weight of a copolymer of a resin. In some exemplary embodiments, the isobornyl (meth)acrylate is present in the amount of from about 80% by weight to about 90% by weight of a copolymer of a resin. The isobornyl (meth)acrylate and butyl (meth)acrylate may be present in any suitable weight ratio relative to one another. For example, the weight ratio of butyl (meth)acrylate to isobornyl (meth)acrylate in the copolymer may be from about 0.1:99.9 to about 35:65, with an exemplary subrange being 15:85 to about 30:70.

The copolymer used for a pigment dispersion resin may have a number average molecular weight (Mn) of 3000 or less, 2500 or less, 2000 or less, 1500 or less, or 1000 or less. The number average molecular weight of a copolymer may be calculated as follows:

Mn=(ΣNᵢMᵢ)/ΣNᵢ

where Mi is the molecular weight of a polymer chain of the copolymer, and Ni is the number of chains of molecular weight Mi in the copolymer. Additionally, the copolymer may have a weight average molecular weight (Mw) of 7000 or less, 6000 or less, 5000 or less, 4000 or less, 3500 or less, 3000 or less, or 2000 or less. The weight average molecular weight of a copolymer may be calculated as follows:

Mw=(ΣNᵢMᵢ²)/(ΣNᵢMᵢ)

where Mᵢ is the molecular weight of a polymer chain of the copolymer, and Nᵢ is the number of chains of molecular weight Mᵢ in the copolymer. It has been found that the mineral spirits tolerance of the copolymer increases as the weight average molecular weight of the copolymer decreases.

The invention encompasses in some embodiments a method of manufacturing a copolymer, the method generally comprising providing monomers and a chain transfer agent dissolved in the solvent, and copolymerizing the monomers to form a copolymer. The provision of monomers dissolved in a solvent may encompass a process including actively dissolving monomers in a solvent or providing a previously prepared solution of monomers dissolved in a solvent. The chain transfer agent may be added to a solvent at any one or more of prior to, after, or during dissolution of monomers in the solvent. The method may further comprise addition of an initiator to the solvent at any one or more of prior to, after, or during dissolution of monomers in the solvent.

The chain transfer agent is employed to limit the molecular weight of the polymer such that it is in the range desired. Any suitable chain transfer agent may be used in a method of manufacturing pigment dispersion resin. For example, a chain transfer agent may include any one or more of mercaptans, such as octyl mercaptan, hexyl mercaptan, 2-mercaptoethanol, n-dodecyl mercaptan, and tertiary dodecyl mercaptan. When used, the chain transfer agent may be employed in an amount ranging from about 1% to about 10% by weight, about 1% to about 7% by weight, or about 1% to about 5% by weight. Likewise, any suitable initiator may be used in a method of manufacturing pigment dispersion resin. For example, an initiator may include any one or more of azo compounds such as 2,2′-azobis(2-methylpropionitrile) and 2,2′-azobis(2-methylbutyronitrile); hydroperoxides such as t-butyl hydroperoxide and cumene hydroperoxide; peracetates such as t-butyl peracetate; peroxides such as benzoyl peroxide, di-tert-butyl peroxide, and methyl ethyl ketone peroxide; peroxyesters such as t-butyl perbenzoate and t-amyl perbenzoate; percarbonates such as isopropyl percarbonate; peroctoates such as t-butylperoctoate; and peroxycarbonates such as butyl isopropyl peroxy carbonate. When used, the initiator may be employed in an amount ranging from about 1% to about 15% by weight of solids, or from about 3% to about 7% by weight of solids.

The resin may be prepared by any suitable technique. The following sequence of steps may be employed to prepare a resin using propylene glycol monomethyl ether acetate solvent, isobornyl (meth)acrylate monomer, methyl (meth)acrylate monomer, n-dodecyl mercaptan, and t-butylperoctoate. One of skill in the art would perform an addition polymerization to make the resin described herein using times and temperatures suitable for the reaction as one of skill in the art would know to do.

1. Charge reactor with solvent and heat to a suitable temperature.

2. Mix, isobornyl (meth)acrylate monomer, methyl (meth)acrylate monomer, n-dodecyl mercaptan together in feed tank and feed over time at temperature.

3. Concurrently with step 2, mix solvent and t-Butylperoctoate initiator together in initiator tank and feed over time at temperature.

4. Subsequently hold the batch at temperature, then reduce the temperature after a suitable time has lapsed to allow the batch to cool to a suitable temperature.

5. Add t-butylperoctoate booster and hold for a suitable time at the lower temperature.

6. Add booster and again hold for a suitable time at the lower temperature.

7. After hold, cool; add solvent to desired solids content.

When used in a pigment dispersion resin, the copolymer may be provided in solution in one or more solvents. The solvent may be the same solvent used to prepare the copolymer, although it is contemplated in some embodiments that additional or different solvents may be employed. Any one or more known solvents suitable for use with a pigment dispersion resin, including polar and nonpolar solvents, may be included in a pigment vehicle. Such solvents may be different or the same as the solvent used to form a coating composition. For example, a solvent included in a pigment vehicle may be propylene glycol monomethyl ether acetate. Other suitable solvents such as ketones, acetones, methyl ethyl ketone, methyl propyl ketone, and methyl isobutyl ketone; glycol ethers such as propylene and ethylene glycol ethers and preferably ethylene glycol monomethyl ether, ethylene glycol monoethyl ether, and ethylene glycol monopropyl ether; acetates such as glycol ether acetates and preferably propylene glycol monomethyl ether acetate; aromatic hydrocarbons such as toluene, naphthalene, and xylene; specialty solvents for compliance in California such as Oxsol 100 and t-butyl acetate, aliphatic hydrocarbons such as pentane, hexane, and heptane; petroleum and wood distillates; turpentine; pine oil; mineral spirits such as odorless mineral spirits and low flash grade, regular grade, or high flash grade mineral spirits of type 0, type 1, type 2, or type 3; and the like. Exemplary pigment dispersion resins include greater than about 20%, 30%, 40%, 50%, 60%, 70%, or 80% by weight of solids or non-volatile matter. In some embodiments, a pigment dispersion resin may include from about 40% to about 70%, from about 40% to about 70%, or from about 50% to about 60% by weight of solids or non-volatile matter.

The pigment dispersion resin is intended for use in the preparation of a pigment vehicle, which comprises the resin and a plurality of pigment particles. It is believed that generally polar, e.g., hydrophilic portions, of monomer units included in a copolymer of a pigment dispersion resin facilitate formulation of pigment vehicle having a high concentration of pigment particles, while still permitting the pigment vehicle to have properties approaching that of a Newtonian fluid. The pigment vehicle may include any suitable pigment particles- and extenders, such as azo pigments, anazurite, aluminum silicate, aluminum potassium silicate, aluminum paste, anthraquinone pigments, antimony oxide, barium metaborate, barium sulfate, cadmium sulfide, cadmium selenide, calcium carbonate, calcium metaborate, calcium metasilicate, carbon black, chromium oxides, clay, copper oxides, copper oxychloride, dioxazine pigments, feldspar, hansa yellows azo pigments (some of which are listed above), benzimidazolones, iron oxides such as yellow and red iron oxides, isoindoline pigments, kaolinite, lithopone, magnesium silicates, metallic flakes, mica, napthol pigments such as napthol reds, nitroso pigments, nepheline syenite, perinone pigments, perylene pigments, polycyclic pigments, pyrropyrrol pigments, pthalocyanines such as copper pthalocyanine blue and copper pthalocyanine green, quinacridones such as quinacridone violets, quinophthalone pigments, silicates, sulfides, talc, titanium dioxide, ultramarine, zinc chromate, zinc oxide, and zinc phosphate. In addition, pearlescents, optical brighteners, ultraviolet stabilizers, and the like may be added to a pigment vehicle. Exemplary pigment vehicles include a weight ratio of pigment to pigment dispersion resin of about 0.1 to about 7, about 0.5 to about 6.0, or about 0.75 to about 5.0.

The pigment vehicle also may include any one or more of dispersants, surfactants, wetting agents, synergists, and rheology modifiers. These materials are preferably soluble in a range of solvents from non-polar solvents, such as odorless mineral spirits, to polar solvents, such as methyl ethyl ketone. Any suitable dispersant, such as any one or more of anionic dispersants, cationic dispersants, amphoteric dispersants, or nonionic dispersants may be used in conjunction with a pigment vehicle. This includes a variety of block copolymer, polyester and acrylic dispersants that are made specificially for use in solventborne pigment dispersions. Exemplary dispersants include Nuosperse® 657 and Nuosperse® FA 196 available from Elementis Specialties, Disperbyk 108 available from Altana AG, and Solsperse™ M387 available from Lubrizol Corporation. Similarly, any suitable wetting agents such as any one or more of anionic wetting agents, cationic wetting agents, amphoteric wetting agents, or nonionic wetting agents may be used in conjunction with a pigment vehicle. Any suitable synergist may be used in conjunction with a pigment vehicle. An exemplary synergist is Solsperse™ 5000 available from Lubrizol Corporation. Any suitable rheology modifier may be used in conjunction with a pigment vehicle. Exemplary rheology modifiers include Suspeno 201-MS available from Poly-Resyn, Inc. and Aerosil® available from Evonik Industries. The pigment vehicle may be prepared from the resin and pigments via any suitable technique.

Exemplary pigment vehicles may include about 15 to about 22 percent by weight of a pigment dispersion resin, about 7 to about 12% by weight of propylene glycol monomethyl ether acetate, about 1 to about 4% by weight of Solsperse™ M387, and about 65 to about 75% by weight of red iron oxide. Yet, other exemplary pigment vehicles may include about 34 to about 44 percent by weight of a pigment dispersion resin, about 24 to about 34 percent by weight of propylene glycol monomethyl ether acetate, about 0.5 to about 1.5 percent by weight of Nuosperse® FA 196, about 2.5 to about 3.5 percent by weight of Solsperse™ M387, and about 24 to about 34 percent by weight of carbon black. In addition, some other exemplary pigment vehicles may include about 27 to about 37 percent by weight of a pigment dispersion resin, about 25 to about 35 percent by weight of propylene glycol monomethyl ether acetate, about 0.5 to about 1.5 percent by weight of Nuosperse® FA 196, about 4 to about 8 percent by weight of Solsperse™ M387, and about 26 to about 36 percent by weight of phthalocyanine-blue pigment (PB 15:2).

A pigment vehicle prepared in accordance with the above teachings may be used to prepare a coating composition. Generally, the method for preparing the coating composition comprises combining a carrier liquid, a binder resin, and a pigment vehicle, where the pigment vehicle comprises a plurality of pigment particles and a pigment dispersion resin. The coating composition generally may be a paint, although it is contemplated in some embodiments that the technology disclosed herein may be employed with other types of coating compositions, such as stains.

The carrier liquid is a fluid component of a coating composition that serves to carry all of the other components of the composition, and that evaporates as a composition dries. Any suitable carrier liquid may be used in methods of manufacturing a coating composition. The carrier liquid may include any one or more of a polar and non-polar solvents, such as the solvents described herein conjunction with a pigment dispersion resin. In addition, the carrier liquid may have the same or different composition as solvents used in pigment dispersion resin, a method of manufacturing a pigment dispersion resin, or a pigment vehicle. Exemplary carrier liquids include ketones, such as acetone, methyl ethyl ketone, methyl propyl ketone, and methyl isobutyl ketone; glycol ethers such as propylene and ethylene glycol ethers and preferably ethylene glycol monomethyl ether, ethylene glycol monoethyl ether, and ethylene glycol monopropyl ether; acetates such as glycol ether acetates and preferably propylene glycol monomethyl ether acetate; aromatic hydrocarbons such as toluene, naphthalene, and xylene; specialty solvents for compliance in California such as Oxsol 100 and t-butyl acetate, aliphatic hydrocarbons such as pentane, hexane, and heptane; petroleum and wood distillates; turpentine; pine oil; mineral spirits such as odorless mineral spirits and low flash grade, regular grade, or high flash grade mineral spirits of type 0, type 1, type 2, or type 3; and the like.

Any suitable binder resin may be used in a method of manufacturing a coating composition. In some embodiments of a method for manufacturing a coating composition, a binder resin preferably includes any one or more of vinyl resins, acrylic resins, modified acrylic resins, vinyl-acrylic alkyds, styrene-acrylic alkyds, acrylic alkyds, epoxy esters, long oil alkyds, short oil alkyds, medium oil alkyds, coconut oil alkyds, phenolic modified alkyds, nitrocellulose resins, CAB resins, polyester resins, epoxy resins A binder resin may be crosslinked. Acrylic polymers are particularly useful. An acrylic polymer is formed from monomers comprising at least one acrylic monomer and may be formed from at least one acrylic monomer and a vinyl aromatic hydrocarbon, such as styrene, a methyl styrene or other lower alkyl styrene, chlorostyrene, vinyl toluene, vinyl naphthalene, or divinyl benzene. Suitable acrylic monomers include any compounds having acrylic functionality, such as alkyl(meth)acrylates, acrylic acids, as well as aromatic derivatives of methacrylic acid, acrylamides and acrylonitrile. Typically, the alkyl(meth)acrylate monomers will have an alkyl ester portion containing from 1 to 12, preferably about 1 to 5, carbon atoms per molecule. Suitable acrylic monomers include, for example, methyl(meth)acrylate, ethyl(meth)acrylate, butyl(meth)acrylate, propyl(meth)acrylate, 2-ethyl hexyl(meth)acrylate, cyclohexyl(meth)acrylate, decyl(meth)acrylate, isodecyl(meth)acrylate, benzyl(meth)acrylate, isobornyl(meth)acrylate, neopentyl(meth)acrylate, 1-adamantyl (meth)acrylate and various reaction products such as butyl, phenyl, and cresyl glycidyl ethers reacted with (meth)acrylic acid, hydroxyl alkyl(meth)acrylates, such as hydroxyethyl and hydroxypropyl(meth)acrylates, amino(meth)acrylates, as well as acrylic acids such as (meth)acrylic acid, ethacrylic acid, alpha-chloroacrylic acid, alpha-cyanoacrylic acid, crotonic acid, beta-acryloxy propionic acid, and beta-styryl acrylic acid. Mixtures of the foregoing are contemplated.

In some embodiments of a method for manufacturing a coating composition, a binder resin may comprise one or more of alkyd or epoxy binder resins. Alkyd resins or polyesters can be prepared in a known manner by the condensation of polyhydric alcohols and polycarboxylic acids, with or without the inclusion of natural drying oil fatty acids as described elsewhere in this specification. The polyesters or alkyds may contain a proportion of free hydroxyl and/or carboxyl groups which are available for reaction, if desired, with suitable crosslinking agents. Epoxy resins generally comprise epoxies in conjunction with one or more an aliphatic or aromatic amine curing agent, polyamide curing agent, or thiol-based curing agent. Exemplary epoxy resins include those formed from Bisphenol A or Bisphenol F, while suitable amine curing agents include aliphatic amines, phenalkamines, cycloaliphatic amines, amido amines, and polyamides. It is contemplated that the alkyd resins will often be used with mineral spirits as the carrier liquid,

Additives may be added at any suitable point during methods of manufacturing a coating composition. Additives that may be included in a coating composition include any one or more of neutralizing agents, antifoaming agents, fillers, dyes, dispersants, surfactants, extenders, adhesion promoters, wetting agents, rheology modifiers, leveling agents, anti-blocking agents, mildewcides, fungicides, algaecides, bactericides, other preservatives, thickeners, thixotropic agents, drying agents, anti-settling agents, and flattening agents. When used, such additives may be present in any amounts suitable for their intended purposes. It is contemplated that some additives will play multiple roles in a coating composition.

Overall, the method of manufacturing a coating composition may generally include four or more stages, including as a pre-thin stage, a grind stage, a wash stage, and a thindown stage. When the coating takes the form of a stain, the method may include a grind stage, a wash stage, and a thindown stage. In the pre-thin stage, one or binder resins may be mixed with a liquid within a thindown tank, and low-shear mixing may be applied in the thindown tank to form a pre-thin mixture. The liquid added during the pre-thin stage may include any one or more of solvents described herein in conjunction with the pigment dispersion resin. In the grind stage, a plurality of pigment particles and the pigment dispersion resin described hereinabove may be mixed in a high-shear mixing device, such as mill, to prepare a grind paste. The high shear applied in the grind stage is intended to break up agglomerates of pigment particles and to ensure the particles are wetted with the resin. A carrier liquid including one or more carrier liquids described herein may also be added during the grind stage. In the wash stage, a wash liquid including one or more solvents described herein in conjunction with the pigment dispersion resin may be pumped into the high-shear mixing device to move the grind paste into a thindown tank. In a thindown stage, the grind paste, the carrier liquid, and the wash liquid are blended together in the thindown tank under low shear conditions. These components also may be blended together with the pre-thin mixture in the thindown tank. The coating composition concentrate may be further let down through further addition of liquid including one or more solvents described herein. A method of manufacturing a coating composition may employ these conventional stages, or a composition may be prepared by other suitable methods, such as employing continuous manufacturing using component slurries.

Once prepared, the coating composition may be dispensed into a storage container, such as a can or bucket. When the storage container is opened, the coating composition may be applied onto a substrate, such as wood, drywall, metal, plastic, or a composite material. Any tool suitable for applying a coating composition, such as a brush, roller, sponge, or spray gun, may be used to apply the composition. Upon application, liquid within the composition will evaporate, and the binder resin of the coating composition will film form to yield a coating.

The following examples are provided to illustrate the present invention but should not be construed as limiting a scope of the invention.

### EXAMPLES

Resin A-1

A reactor flask was filled with propylene glycol monomethyl ether acetate (1000 g). Then isobornyl methacrylate monomer (1175 g.), styrene monomer (618.5 g.), methyl methacrylate monomer (206 g.) and n-dodecyl mercaptan (85 g.) were added to another vessel. Next, 11 grams of 2,2′-azobis(2-methylbutyronitrile) along with said solvent, were added to the monomers in the vessel. The monomers were polymerized to produce resin composition A-1. Resin A-1 comprised 60% by weight of non-volatile matter and 40% by weight of propylene glycol monomethyl ether acetate. The copolymer present in resin A-1 included 59% by weight of monomer units derived from isobornyl methacrylate, 10% by weight of monomer units derived from styrene, and 31% by weight of monomer units derived from methyl methacrylate. The copolymer in resin A-1 had a number average molecular weight (Mn) of 2416, a weight average molecular weight (Mw) of 6467 and a Gardner bubble viscosity of Y.

Resin A-2

A reactor flask was filled with propylene glycol monomethyl ether acetate (1000 g). Then isobornyl methacrylate monomer (1673 g.), styrene monomer (0 g.), methyl methacrylate monomer (295 g.) and n-dodecyl mercaptan (82 g.) were added to another vessel. Next, 46 grams of t-butylperoctoate, along with said solvent, were added to the monomers in the vessel. The monomers were polymerized to produce resin composition A-2. Resin A-2 comprised 60% by weight of non-volatile matter and 40% by weight of propylene glycol monomethyl ether acetate. The copolymer present in resin A-2 included 85% by weight of monomer units derived from isobornyl methacrylate, and 15% by weight of monomer units derived from methyl methacrylate. The copolymer in resin A-2 had a number average molecular weight (Mn) of 1316, a weight average molecular weight (Mw) of 3860 and a Gardner bubble viscosity of W+.

Resin A-3

A reactor flask was filled with propylene glycol monomethyl ether acetate (1000 g). Then isobornyl methacrylate monomer (1675 g.), styrene monomer (0 g.), n-butyl methacrylate monomer (295 g.) and n-dodecyl mercaptan (83 g.) were added to another vessel. Next, 47 grams of t-butylperoctoate, along with said solvent, were added to the monomers in the vessel. The monomers were polymerized to produce resin composition A-3. Resin A-3 comprised 60% by weight of non-volatile matter and 40% by weight of propylene glycol monomethyl ether acetate. The copolymer present in resin A-3 included 85% by weight of monomer units derived from isobornyl methacrylate and 15% by weight of monomer units derived from n-butyl methacrylate. The copolymer in resin A-3 had a number average molecular weight (Mn) of 1431, a weight average molecular weight (Mw) of 3579 and a Gardner bubble viscosity of X−.

Resin A-4

A reactor flask was filled with propylene glycol monomethyl ether acetate (1008 g). Then isobornyl methacrylate monomer (1162 g.), styrene monomer (616 g.), methyl methacrylate monomer (217 g.) and n-dodecyl mercaptan (84 g.) were added to another vessel. Next, 48 grams t-amyl peroxyethylhexanoate along with said solvent, were added to the monomers in the vessel. The monomers were polymerized to produce resin composition A-4. Resin A-4 comprised 60% by weight of non-volatile matter and 40% by weight of propylene glycol monomethyl ether acetate. The copolymer present in resin A-4 included 58% by weight of monomer units derived from isobornyl methacrylate, 30% by weight of monomer units derived from styrene, and 11% by weight of monomer units derived from methyl methacrylate. The copolymer in resin A-4 had a number average molecular weight (Mn) of 1893, a weight average molecular weight (Mw) of 4830 and a Gardner bubble viscosity of X−.

Resin A-5

A reactor flask was filled with propylene glycol monomethyl ether acetate (996 g). Then isobornyl methacrylate monomer (1175 g.), styrene monomer (619 g.), methyl methacrylate monomer (186 g.), glacial methacrylic acid (20 g.) and n-dodecyl mercaptan (85 g.) were added to a seperate vessel. Next, 12.5 grams of 2,2′-azobis(2-methylbutyronitrile) along with said solvent, were added to the monomers in the vessel. The monomers were polymerized to produce resin composition A-5. Resin A-5 comprised 60% by weight of non-volatile matter and 40% by weight of propylene glycol monomethyl ether acetate. The copolymer present in resin A-5 included 59% by weight of monomer units derived from isobornyl methacrylate, 31% by weight of monomer units derived from styrene, and 9% by weight of monomer units derived from methyl methacrylate. The copolymer in resin A-5 had a number average molecular weight (Mn) of 2310, a weight average molecular weight (Mw) of 6483 and a Gardner bubble viscosity of Y−.

For comparison, UNICHROMA resin produced by the Sherwin-Williams Company was selected for Comparative Example 1, LAROPAL® A 81 was selected for Comparative Example 2, PARALOID™ DM-55 was selected for Comparative Example 3, and DIANAL TB-219 from Dianal America, Inc. was selected for Comparative Example 4.

Testing

Resins A-1 through A-5 and Comparative Examples 1-4 were tested for solubility in odorless mineral spirits by adding 25 g. of 60% resin into PM acetate (which equates to 15 g. resin to 10 g. of PM acetate). The results of the solubility test are shown in the following table:

| | Resin | Resin | Resin | Resin | Resin | | | | |
|---|---|---|---|---|---|---|---|---|---|
| | A-1 | A-2 | A-3 | A-4 | A-5 | C. Ex. 1 | C. Ex. 2 | C. Ex. 3 | C. Ex. 4 |
| Solubility | 5.92 | Infinite | 6.79 | 6.73 | Infinite | 1.38 | 1.52 | 1.62 | 2.83 |
| in | | | | | | | | | |
| odorless | | | | | | | | | |
| mineral | | | | | | | | | |
| spirits | | | | | | | | | |

Pigment vehicles prepared using Resin A-2 and using Dow DM-55 (“Maxitoner”) were evaluated for compatibility with mineral spirits, as follows.

In each case, from a one-gallon can of stain, about 1/20th of the composition was dispensed into half-pint cans. To each half-pint can was added 0.1 fluid oz. of test colorant. The cans were shaken for one minute, opened to pour off about 30 ml of fluid, and closed and shaken for another two minutes. After pouring off another 30 ml of fluid, the cans were closed and shaken for twelve additional minutes. The samples were applied side-by-side-by-side to white bond paper and drawn down with a #42 wire-round rod. After waiting until the surface no longer appeared wet, using a gloved finger, the painted surfaces were contacted and a circular motion was made for 5-10 seconds in a clockwise direction and 5-10 seconds in a counterclockwise direction at the top and bottom of each of the three samples.

| | |
|---|---|
| Resin A-2 | Maxitoner |

| COMPONENT | % [wt] | COMPONENT | % [wt] |
|---|---|---|---|
| Resin | 32% | DM-55 Resin | 31% |
| PM Acetate | 43% | PM Acetate | 34% |
| Dispersant | 3% | Dispersant | 15% |
| Pigment | 21% | Pigment | 20% |

The results, after the paper dried fully, are shown in the FIGURE. As seen, the pigment vehicle prepared using the DM-55 resin (top row) were not easily dissolved by the odorless mineral spirits, and were unsatisfactory. The exemplary pigment vehicle (bottom row) exhibited essentially no gritting and was substantially completely soluble in odorless mineral spirits.

It is thus seen that the present disclosure provides a pigment dispersion resin, a method of manufacturing a pigment dispersion resin, a pigment vehicle, a method of manufacturing a coating composition, a coating composition, a method of coating a substrate.

Description of an amount of monomer units is intended to describe a percentage by weight of the monomer units based on a total weight of a copolymer including the monomer units. Description of “(meth)acrylate” is intended to cover monomers comprising (or monomer units derived from) methacrylate or acrylate structures. Description of monomer units is intended to cover at least monomer units derived from monomers and monomer units derived from oligomers including the monomer units.

All methods described herein can be performed in any suitable order unless otherwise indicated herein or otherwise clearly contradicted by context. The use of any and all examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. A pigment dispersion resin comprising a copolymer including monomer units derived from isobornyl (meth)acrylate and methyl (meth)acrylate, said monomer units derived from isobornyl (meth)acrylate being present in said copolymer in an amount greater than about 55% by weight, said copolymer having a number average molecular weight of 3000 or less, and said resin being substantially completely soluble in mineral spirits.

2. A resin according to claim 1, said copolymer being essentially free of hydrophilic functional groups derived from monomers other than isobornyl (meth)acrylate and methyl (meth)acrylate.

3. A resin according to claim 1, said copolymer having a weight average molecular weight of 7000 or less.

4. A resin according to claim 1, said resin being substantially completely soluble in ketone, acetate, and aromatic solvents.

5. A resin according to claim 1, said copolymer further including monomer units derived from styrene and having a glass transition temperature greater than 25° C.

6. A resin according to claim 5, said monomer units derived from methyl (meth)acrylate being present in said copolymer in an amount greater than about 5% by weight, and said monomer units derived from styrene being present in said copolymer in an amount greater than about 25% by weight.

7. A resin according to claim 1, said monomer units derived from isobornyl (meth)acrylate being present in said copolymer in an amount greater than about 70% by weight.

8. A resin according to claim 1, said monomer units derived from isobornyl (meth)acrylate being present in said copolymer in an amount greater than about 75% by weight.

9. A resin according to claim 1, said monomer units derived from isobornyl (meth)acrylate being present in said copolymer in an amount greater than about 75% by weight, and said monomer units derived from methyl (meth)acrylate being present in said copolymer in an amount greater than about 20% by weight.

10. A pigment dispersion resin comprising a copolymer including monomer units derived from isobornyl (meth)acrylate, butyl (meth)acrylate, and methyl (meth)acrylate, said monomer units derived from isobornyl (meth)acrylate and butyl (meth)acrylate collectively being present in said copolymer in an amount greater than about 55% by weight, said copolymer having a number average molecular weight of 3000 or less, and said resin being substantially completely soluble in mineral spirits.
